(19) United States
(12) Patent Application Publication
(10) Pub. No.: US 2018/0307063 A1
(43) Pub. Date: Oct. 25, 2018

(54) FAR FIELD SPATIAL MODULATION

(71) Applicant: MACOM Technology Solutions Holdings, Inc., Lowell, MA (US)

(72) Inventor: Cristian Stagarescu, Ithaca, NY (US)

(21) Appl. No.: 15/955,102

(22) Filed: Apr. 17, 2018

Related U.S. Application Data
(60) Provisional application No. 62/487,034, filed on Apr. 19, 2017.

(51) Int. Cl. G02F 1/025

(52) U.S. Cl. CPC G02F 1/025; G02F 2001/0155

(57) ABSTRACT

Embodiments of an optical modulator device are described. An example optical modulator includes a ridge laser configured to emit light, a ridge waveguide configured to transition between a transparent state and an absorbing state, and a waveguide tap formed between the ridge laser and the ridge waveguide. The waveguide tap is configured to optically couple a fraction of light generated in the ridge laser to the ridge waveguide. In the transparent state of the ridge waveguide, the ridge waveguide is configured to output the fraction of light for interference with light emitted from the ridge laser. In the absorbing state of the ridge waveguide, the ridge waveguide is configured to absorb the fraction of light. Depending upon whether the fraction of light is output from the ridge waveguide for interference, the output power of the laser seen at the far-field of the optical modulator can be modulated for data communications.

### CROSS-REFERENCE TO RELATED APPLICATIONS

This application claims the benefit of U.S. Provisional Application No. 62/487,034, filed Apr. 19, 2017, the entire contents of which is hereby incorporated herein by reference.

### BACKGROUND

In silicon photonics (SiPh), optical devices are integrated with electronic components using semiconducting materials and semiconductor manufacturing techniques. Among other uses, SiPh devices can be relied upon to communicate data between optical transmitters and receivers. In an optical transmitter, data is used to modulate light, such as that produced by a light or laser emitting diode, and the modulated light can be transmitted to an optical receiver over waveguides, fiber optic cables, etc. Modulated light streams (e.g., optical data streams) are more suitable for long distance, low loss data transmission as compared to data transmitted in the electrical domain.

Electrical current is converted in optical transmitters to optical power, and optical power is converted in optical receivers back to electrical current. In various modulation schemes, the magnitudes of the currents are proportional to the corresponding levels of optical power. The extinction ratio can be defined as the ratio of the optical power level when the optical light source is “on” (e.g., state P1 or data “one”) and the optical power level with the optical light source is “off” (e.g., state P0 or data “zero”).

### BRIEF DESCRIPTION OF THE DRAWINGS

Aspects of the present disclosure can be better understood with reference to the following drawings. It is noted that the elements in the drawings are not necessarily to scale, with emphasis instead being placed upon clearly illustrating the principles of the embodiments. In the drawings, like reference numerals designate like or corresponding, but not necessarily the same, elements throughout the several views.

FIG. 1 illustrates an example optical modulator device according to various embodiments described herein.

FIG. 2 illustrates an example ridge laser and ridge waveguide with far-field intensity chart to illustrate various aspects of the embodiments.

FIG. 3A illustrates an example ridge laser and ridge waveguide with contour map of the electric field to illustrate various aspects of the embodiments.

FIG. 3B illustrates an example far-field intensity chart to illustrate various aspects of the embodiments.

FIG. 4 illustrates an example of the optical modulator device shown in FIG. 1 where the output facet of the ridge waveguide is extended according to various embodiments described herein.

FIG. 5 illustrates a perspective view of another optical modulator similar to that shown in FIG. 1 according to various embodiments described herein.

FIG. 6 illustrates a process of far field spatial modulation that can be performed by the optical modulator devices described herein according to various embodiments described herein.

### DETAILED DESCRIPTION

In optical communications systems, electrical current is converted to optical power in optical transmitters, and optical power is converted back to electrical current in optical receivers. In various modulation schemes, the magnitudes of the currents are proportional to the corresponding levels of optical power. The extinction ratio can be defined as the ratio of the optical power level when the optical light source is “on” (e.g., state P1 or data “one”) and the optical power level with the optical light source is “off” (e.g., state P0 or data “zero”).

In an ideal optical transmitter, P0 would be zero and thus the extinction ratio would be infinite. For high speed operations in practical optical transmitters, however, the laser is typically biased in the vicinity of the laser threshold even in the P0 state, and P0>0. Thus, in optical transmitters that rely upon direct modulation lasers (DML), a bias current of greater than zero is used to bias the laser to a level at or above its laser threshold for the P0 state. An additional amount of current, which can be called the modulating or drive current, is supplied to the laser to drive it to the higher optical power level for the P1 state.

As an alternative to directly modulating the laser in an optical transmitter, the laser can be biased for a desired output power in a constant wave mode of operation. Then, without directly modifying the output power level of the laser for modulation, the light output from the laser can be modulated to transition between the data “one” and “zero” states. For example, a Mach Zender (MZ) modulator can be used to modulate the light output from the laser.

In the context outlined above, embodiments of an optical modulator device are described. An example optical modulator includes a ridge laser configured to emit light, a ridge waveguide configured to transition between a transparent state and an absorbing state, and a waveguide tap formed between the ridge laser and the ridge waveguide. The waveguide tap is configured to optically couple a fraction of light generated in the ridge laser to the ridge waveguide. In the transparent state of the ridge waveguide, the ridge waveguide is configured to output the fraction of light for interference with light emitted from the ridge laser. In the absorbing state of the ridge waveguide, the ridge waveguide is configured to absorb the fraction of light to prevent any interference with light emitted from the ridge laser. Depending upon whether or not the fraction of light is output from the ridge waveguide, the output power of the laser seen at the far-field of the optical modulator can be modulated for data communications.

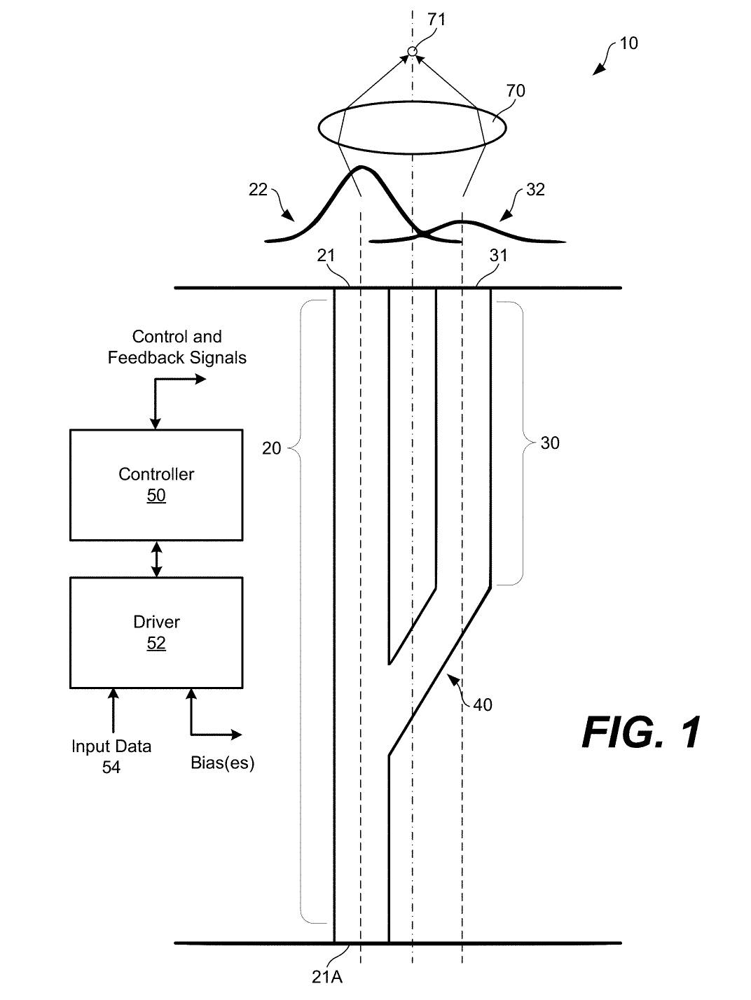

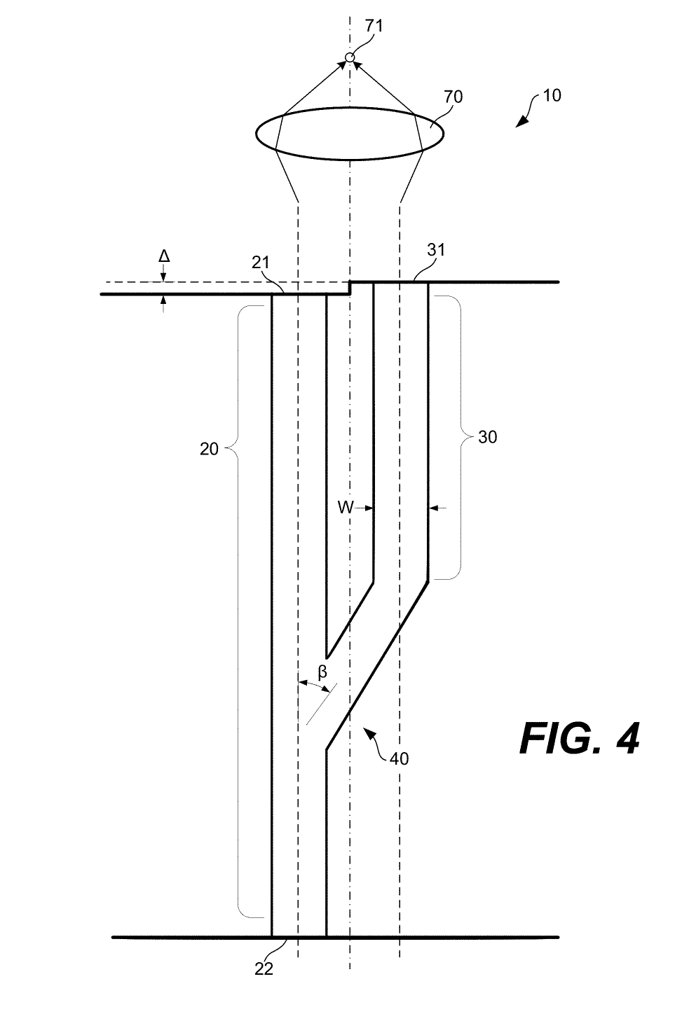

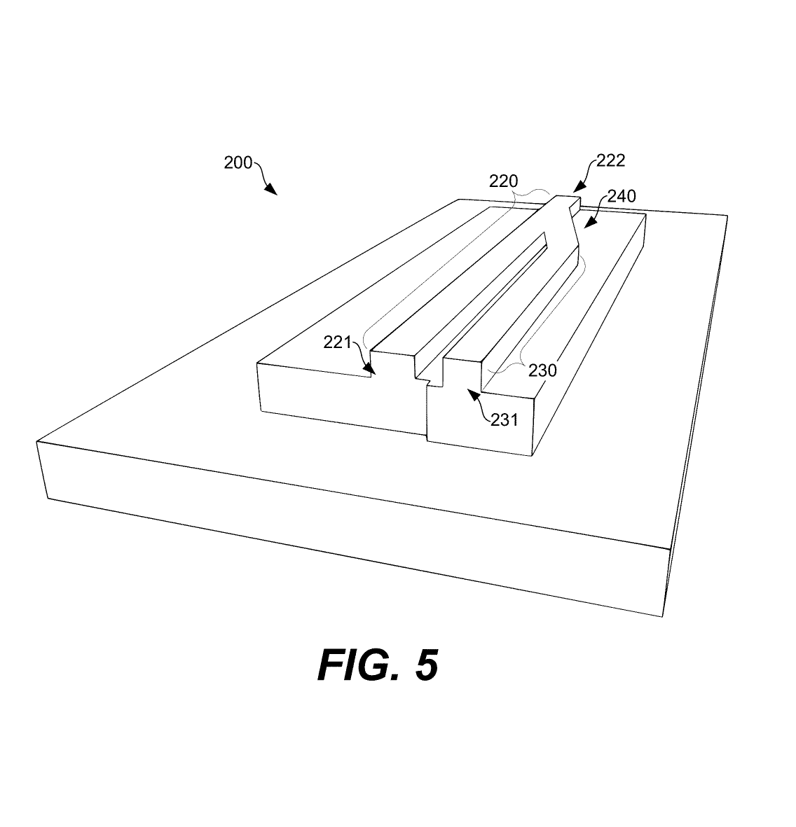

Turning to the drawings, FIG. 1 illustrates an example optical modulator 10 according to various embodiments described herein. The optical modulator 10 is presented as one representative example of an optical modulator according to the embodiments described herein. The optical modulator 10 is not necessarily drawn to scale and can vary in size and proportion as compared to that shown in FIG. 1. Additionally, variations on the structure of the optical modulator 10 are within the scope of the embodiments, and FIGS. 4 and 5 illustrate other configurations of other optical modulators consistent with the concepts described herein.

As shown in FIG. 1, the optical modulator 10 comprises a ridge laser 20, a ridge waveguide 30, and a waveguide tap 40 formed between the ridge laser 20 and the ridge waveguide 30. As described in further detail below, the waveguide tap 40 is formed and configured to optically couple a fraction of light generated in the ridge laser 20 to the ridge waveguide 30. The ridge laser 20 includes an output facet 21 and an end facet 21A, and the ridge waveguide 30 includes an output facet 31.

Although not necessarily integrated with the optical modulator 10, FIG. 1 also illustrates a controller 50 and a driver 52. The controller 50 and the driver 52 can be designed as integrated circuit chips for supporting, controlling, and driving the optical modulator 10. The optical modulator 10, controller 50, and driver 52 can interface with each other over one or more proprietary and/or standard interfaces. In that context, the interfaces can include any suitable combination of digital and/or analog control, driver, feedback, etc. interfaces. In one example, the optical modulator 10, controller 50, and driver 52, among other components, can be packaged together in a standard form factor package. The optical modulator 10, controller 50, and driver 52 can also be mounted directly on one or more system circuit boards in a method known as chip-on-board.

The controller 50 can be embodied as circuits or circuitry, including general purpose or application specific integrated circuit (ASIC) processors, with memory. In that context, the controller 50 can be configured to control the operations of the optical modulator 10, in connection with the driver 52, to generate modulated light according to one or more optical communications standards. The controller 50 is configured to control and monitor the operations of the optical modulator 10. The controller 50 is also configured to control and monitor the configuration and status of the optical modulator 10. For example, through one or more local interfaces with the optical modulator 10 and/or the driver 52, the controller 50 is configured to control and monitor the temperature, output power, and other operating characteristics and parameters of the optical modulator 10. To that end, the controller 50 can include one or more timers, event detectors, power calculators, and tuning modules, among other components.

The driver 52 can be embodied as an integrated circuit device for high speed input data recovery, reconstruction and conditioning, clock recovery and data retiming, and bias driving (e.g., current and/or voltage). For control, the driver 52 can include a number of internal registers accessible to other devices, such as the controller 50, through a local interface. The driver 52 can also include driver circuitry configured to provide power to bias the optical modulator 10. One or more channels of input data signals 54 can be provided to the driver 52. To recover and reconstruct the input data signals 54, the driver 52 can include adaptive or programmable input buffers, filters, equalizers, etc.

To generate modulated light using the optical modulator 10, the driver 52 can supply one or more bias currents and/or voltages to the optical modulator 10 based on the input data signals 54. Thus, the driver 52 can supply one or more biases to one or both of the ridge laser 20 and the ridge waveguide 30, among other elements. In various embodiments, the driver 52 can also supply biases to one or more heaters and other elements that can be integrated with the optical modulator 10. The driver circuitry in the driver 52 can be programmed to provide a range of bias voltages and/or currents, in certain increments. In one configuration, the controller 50 and the driver 52 can be programmed to provide bias voltages and/or currents to the optical modulator 10 over a relatively narrow range of voltages and/or currents.

In one example case, the optical modulator 10 can be can be formed on a semiconductor substrate including Indium and Phosphorus (InP) using any suitable semiconductor manufacturing techniques. The optical modulator 10 can be constructed from materials which exhibit a direct band gap suitable for optoelectronic devices, including laser diodes, semiconductor optical amplifiers, optical switches, and other optical components. For example, the optical modulator 10 can be formed from group II-V or group III-V compound material semiconductors including combinations of Indium, Aluminum, Gallium, Arsenide, Phosphorus, and other elements, such as GaAs/AlGaAs, InP/InGaAs, InP/InGaAsP, and InP/AlInGaAs, among other elements.

To form the optical modulator 10, a succession of one or more layers can be deposited on a top surface of a substrate. The layers form optical waveguides for the ridge laser 20, the ridge waveguide 30, and the waveguide tap 40. The layers can be deposited using an epitaxial deposition process, such as Metalorganic Chemical Vapor Deposition (MOCVD) or Molecular Beam Epitaxy (MBE), among other manufacturing techniques. In one example case, the layers can be formed using manufacturing techniques consistent with those described in U.S. Pat. No. 8,009,711, titled “Etched-facet Ridge Lasers with Etch-Step,” the entire disclosure of which is hereby incorporated herein by reference.

The layers of the optical modulator 10 that form the ridge laser 20 can include an active region formed, for example, by AlInGaAs-based quantum wells, barriers, and adjacent upper and lower cladding regions (e.g., to provide a lasing medium and/or region). The layers can be epitaxially formed on an InP substrate, with upper and lower cladding regions formed from a semiconductor material such as InP, which has a lower index than the index of the active region. An InGaAs cap layer can be provided on the top surface of the upper cladding layer to provide one or more ohmic contacts. During operation, the ridge laser 20 can be biased by the driver 52 to emit light exhibiting power at a particular wavelength or over a relatively narrow range of wavelengths from the output facet 21.

The layers of the optical modulator 10 that form the ridge waveguide 30 can omit the active region which forms a lasing medium in the ridge laser 20. However, the layers can be formed so that the ridge waveguide 30 is configured to be modulated between transparent and absorbing states. Particularly, the ridge waveguide 30 can be modulated between transparent and absorbing states by the driver 52 through bias current injection, reverse biasing, etc., based on the input data signals 54 provided to the driver 52. For modulation according to the concepts described herein, the ridge waveguide 30 can be biased (or reverse biased, etc.) with current to transition it between transparent and absorbing states. Even in the transparent and absorbing states, the ridge waveguide 30 is not operated in a lasing mode. In one example, the ridge waveguide 30 can also be electrically (but not optically) isolated from the ridge laser 20. Thus, the driver 52 can provide separate bias currents to the ridge laser 20 and the ridge waveguide 30 for lasing and modulating, respectively, as described herein.

A fraction of the light generated in the ridge laser 20 can be tapped coherently from the ridge laser 20 to the ridge waveguide 30 by the waveguide tap 40. The waveguide tap 40 can be embodied as one or more layers in the optical modulator 10 that form a passive optical waveguide between the ridge laser 20 and the ridge waveguide 30. Depending upon the structural design of the waveguide tap 40, some characteristics of which are described below with reference to FIG. 4, the fraction of light tapped coherently from the ridge laser 20 to the ridge waveguide 30 can be greater or lower. In one embodiment, about 5-10% of the light generated in the ridge laser 20 is tapped coherently from the ridge laser 20 to the ridge waveguide 30, but other ranges are within the scope of the embodiments. The light is tapped into the ridge waveguide 30 for interference with and to modulate the light output from the ridge laser 20. With that amount of light (e.g., about 5-10%) used for interference as described herein, the optical modulation 10 can achieve an extinction ratio of over −3 dB between modulated states.

As light from the ridge laser 20 is tapped to the ridge waveguide 30, the ridge waveguide 30 can be modulated between transparent and absorbing states by the driver 52. When the ridge waveguide 30 is in the absorbing state, any light fed into it from the ridge laser 20 will be absorbed. On the other hand, when the ridge waveguide 30 is in the transparent state, at least a portion of the light fed into it from the ridge laser 20 will be guided through to the output facet 31. The output facet 31 can be designed for relatively little back reflection into the ridge waveguide 30 so that the ridge waveguide 30 does not independently lase. Thus, because the ridge waveguide 30 is not operated as a laser, it can provide high modulation speeds and low chirp levels.

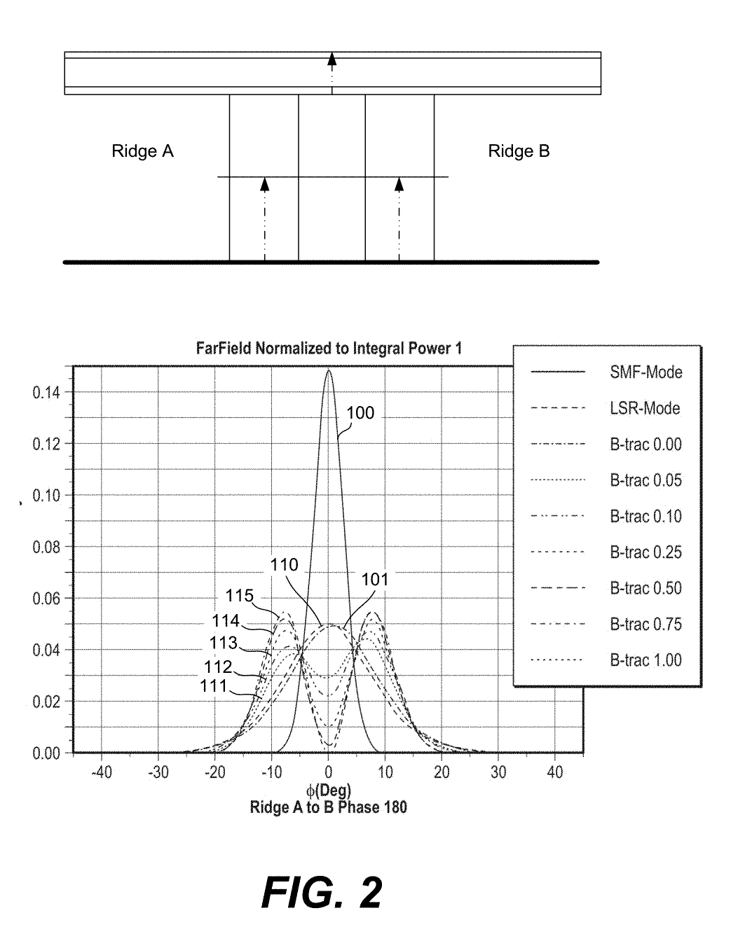

When the ridge laser 20 is biased to emit light from the output facet 21 and the ridge waveguide 30 is in the transparent state, light output from the output facet 31 of the ridge waveguide 30 can interfere with the light output from the output facet 21. The lobe 22 in FIG. 1 is representative of the near-field light output from the output facet 21, which is the main output of light from the optical modulator 10. The lobe 32 in FIG. 1 is representative of the near-field light output from the output facet 31, which is used in the embodiments to distort the light output from the output facet 21. Particularly, as described in further detail below with reference to FIGS. 2-5, a separation or spatial offset between the output facets 21 and 31 can result, due to light interference, in a distorted, two-lobe near-field response (e.g., the interference of the lobes 22 and 32) at an output of the optical modulator 10 when light is output from both the output facets 21 and 31 (e.g., an OFF state). On the other hand, when the ridge waveguide 30 is absorbing and no light is output from the output facet 31, the lobe 22 exhibits a clean, single-lobed near-field response (e.g., an ON state).

In one embodiment, light output from the optical modulator 10 can be coupled through a spherical ball lens 70 to a focus point 71. However, coupling through the spherical ball lens 70 can be considerably reduced due to spherical aberration for the two-lobe OFF response as compared to the single-lobed ON response, leading to a high extinction ratio. Thus, for the OFF state, the amplitude of light that reaches the far-field focus point 71 can be significantly reduced as compared to that for the ON state.

FIG. 2 illustrates an example ridge laser and ridge waveguide with far-field intensity chart. In order to estimate relative values and coupling, the far-fields curves have been normalized to unit area. In FIG. 2, ridge A is representative of the ridge laser 20 in FIG. 1, and ridge B is representative of the ridge waveguide 30 in FIG. 1. The intensity response 100 is representative of the far-field power intensity of light output from a single-mode-fiber mode (SMF-Mode), and the intensity response 101 is representative of the far-field power intensity of light output from ridge A (LSR-Mode). In the simulation, the light output from ridge B was allowed to interfere with that from ridge A. In the simulation, the power of the light output from ridge B was set at various fractions (B-frac) of that output from ridge A.

As shown in Table 1 below, for the distorted interference intensity responses 110-115 shown in FIG. 2, the intensity of the light output from ridge B was set as a fraction of 0.05, 0.01, 0.25, 0.5, 0.75, and 1, respectively, of that output from ridge A. Additionally, the phase of the light output from ridge B was shifted 180° in phase as compared to that output from ridge A. In order to estimate relative fractions and coupling values, all the far-fields have been normalized to unit area. In Table 1, the VAL column represents the value of the far-field intensity on the optical axis at zero degrees angle. Since spherical lenses have strong aberrations for beam directions angled away from optical axis, column C1, which is VAL as fraction of the SMF far-field intensity at zero angle, represents an estimate of the coupling through a spherical lens into a single-mode optical fiber. Column C2, which is VAL as fraction of the laser LSR mode far-field intensity at zero angle, represents an estimate of the extinction ratio.

The extinction ratio, shown in the C2 column in Table 1, increases (e.g., increasing negative dB) as the intensity of the light output from ridge B increases. In other words, for increased coupling of light from ridge A to ridge B, the extinction ratio increases. For the purposes of distinguishing between the ON and OFF states of modulation, a suitable extinction ratio can be selected at about −3 dB, for example, for good signal to noise ratio.

TABLE 1

| | VAL | C1 | C2 |
|---|---|---|---|
| SMF Mode | 0.014849 | 1.000 | — |
| LSR Mode | 0.004992 | 0.336 | 0.0 |
| B Output as Fraction | 0.005013 | 0.337 | 0.0 |
| of A = 0.00 | | | |
| B Output as Fraction | 0.002930 | 0.197 | −2.31 |
| of A = 0.05 | | | |
| B Output as Fraction | 0.002196 | 0.147 | −3.59 |
| of A = 0.10 | | | |
| B Output as Fraction | 0.001052 | 0.070 | −6.81 |
| of A = 0.25 | | | |
| B Output as Fraction | 0.000304 | 0.020 | −12.25 |
| of A = 0.50 | | | |
| B Output as Fraction | 5.4e−05 | 0.0036 | −19.7 |
| of A = 0.75 | | | |
| B Output as Fraction | 3.0e−17 | 2.0e−15 | −142 |
| of A = 1.00 | | | |

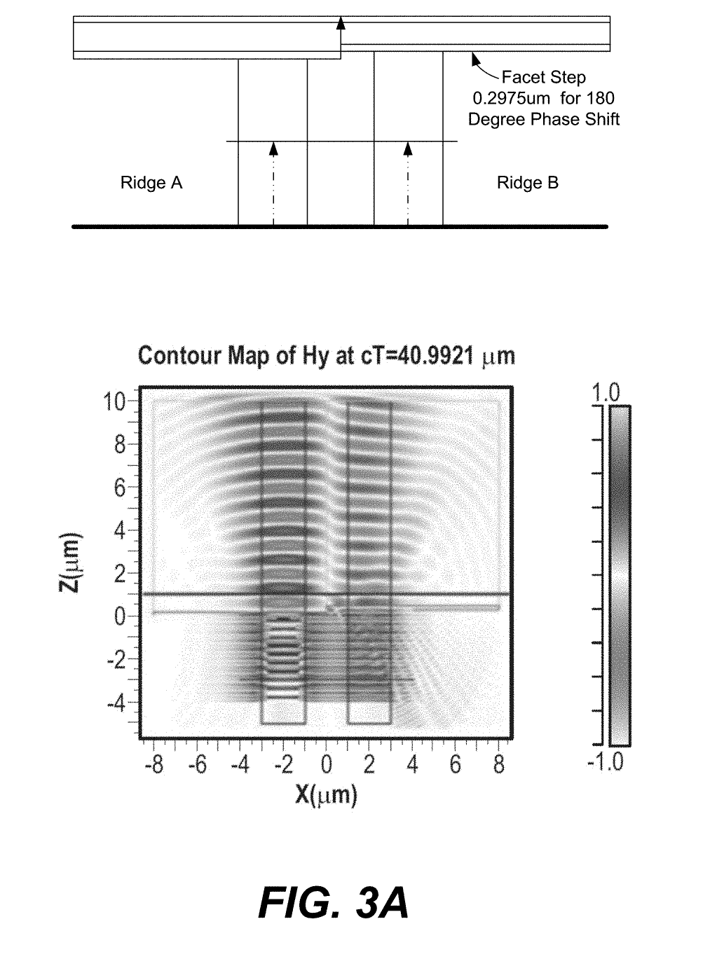

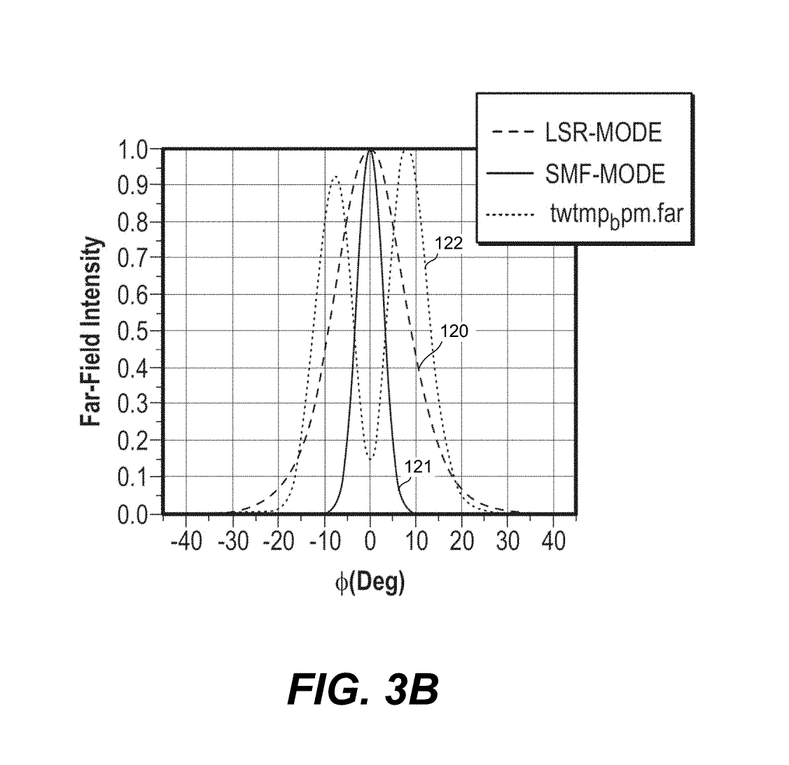

FIG. 3A illustrates an example ridge laser and ridge waveguide with contour map. In FIG. 3, ridge A is representative of the ridge laser 20 in FIG. 1, and ridge B is representative of the ridge waveguide 30 in FIG. 1. However, the output facet of ridge B is extended or stepped 0.2975 μm beyond the output facet of ridge A. Due to the extension of the output facet of ridge B, the phase of the light output from the output facet of ridge B is shifted 180° in phase as compared to that output from the output facet of ridge A. As described below, other lengths of extension and corresponding phase shifts can be used.

In FIG. 3A, a representative illustration of the interference of light output from ridges A and B is shown in the electric field contour map. In the simulation, the amplitude or intensity of the light output from ridge B was set as a fraction of one quarter of the amplitude or intensity of the light output from ridge A.

In FIG. 3B, the far-field intensity chart shows laser (LSR) mode intensity response 120, SMF mode intensity response 121, and interference intensity response 122 of the structure shown in FIG. 3A. As shown, the interference intensity response 122 is a distorted, two-lobe intensity response. Thus, when using a spherical ball lens, for example, for far-field focusing, a high extinction ratio can be expected between the response 120 and the distorted interference intensity response 122.

FIG. 4 illustrates an example of the optical modulator 10 shown in FIG. 1 where the output facet 31 of the ridge waveguide 30 is extended as compared to the output facet 21 of the ridge laser 20. The output facet 31 is formed to extend beyond the output facet 21 so that the light output from the output facet 31 is shifted in phase with respect to the light emitted from the output facet 21. In one example case, the output facets 21 and 31 can be formed, at different, flat planes, using the manufacturing technique described in U.S. Pat. No. 8,009,711, although any other suitable semiconductor manufacturing technique can be used.

The offset or distance Δ between the output facets 21 and 31, as shown in FIG. 4, can be determined based on various factors, such as the wavelength of light being generated by the optical modulator 10, the desired phase shift between the light output from the output facets 21 and 31, and other factors. In one example case, the distance Δ between the output facets 21 and 31 can be selected at about 0.2975 μm, although other suitable distances can be used. For a distance Δ at about 0.2975 μm, the phase of the light output from the output facet 31 can be shifted in phase by about 180° as compared to that output from the output facet 21.

In other structural variations of the optical modulator 10, the spacing between the ridge laser 20 and the ridge waveguide 30 can vary among the embodiments. Further, the angle β between the central axis of the ridge laser 20 and the central axis of the waveguide tap 40 can vary as one factor to control the amount of light that is coupled from the ridge laser 20 into the ridge waveguide 30. The width W of the ridge waveguide 30 and/or the waveguide tap 40 can also be varied. Additionally, the length of the ridge waveguide 30 and/or the placement of the waveguide tap 40 between the ridge laser 20 and the ridge waveguide 30 can be varied as compared to that shown in FIG. 4.

FIG. 5 illustrates a perspective view of another optical modulator 200 similar to that shown in FIG. 1 according to various embodiments described herein. The optical modulator 200 comprises a ridge laser 220, a ridge waveguide 230, and a waveguide tap 240 formed between the ridge laser 220 and the ridge waveguide 230. As described in further detail below, the waveguide tap 240 is formed and configured to optically couple a fraction of light generated in the ridge laser 220 to the ridge waveguide 230. The ridge laser 220 includes an output facet 221 and an end facet 222, and the ridge waveguide 230 includes an output facet 231. As shown, the output facet 231 extends a distance beyond the output facet 221, consistent with the concepts described herein.

Similar to the optical modulator 10 shown in FIG. 1, a fraction of the light generated in the ridge laser 220 of the optical modulator 200 can be tapped coherently from the ridge laser 220 to the ridge waveguide 230 by the waveguide tap 240. The waveguide tap 240 forms a passive optical waveguide between the ridge laser 220 and the ridge waveguide 230. Depending upon the design of the waveguide tap 240, the fraction of light tapped coherently from the ridge laser 220 to the ridge waveguide 230 can be in the range of about 5-10% of the light generated in the ridge laser 220. When the light tapped into the ridge waveguide 230 is output from the output facet 231, it can interfere with and modulate the light output from the output facet 221 of the ridge laser 220.

As light from the ridge laser 220 is tapped to the ridge waveguide 230, the ridge waveguide 230 can be modulated between transparent and absorbing states by circuitry similar to the driver 52 discussed above. When the ridge waveguide 230 is in the absorbing state, any light fed into it from the ridge laser 220 can be absorbed. On the other hand, when the ridge waveguide 230 is in the transparent state, at least a portion of the light fed into it from the ridge laser 220 can be guided through to the output facet 231. The output facet 231 can be designed for relatively little back reflection into the ridge waveguide 230 so that the ridge waveguide 230 does not independently lase. Thus, because the ridge waveguide 230 is not operated as a laser, it can provide high modulation speeds and low chirp levels.

When the ridge laser 220 is biased to emit light from the output facet 221 and the ridge waveguide 230 is in the transparent state, light output from the output facet 231 of the ridge waveguide 230 can interfere with the light output from the output facet 221. Particularly, the spatial offset between the output facets 221 and 231 results in a distorted near-field response at an output of the optical modulator 200 when light is output from both the output facets 221 and 231 (e.g., an OFF state). On the other hand, when the ridge waveguide 230 is absorbing and no light is output from the output facet 231, the output of the optical modulator 200 exhibits a clean, single-lobed near-field response (e.g., an ON state) according to the concepts described herein.

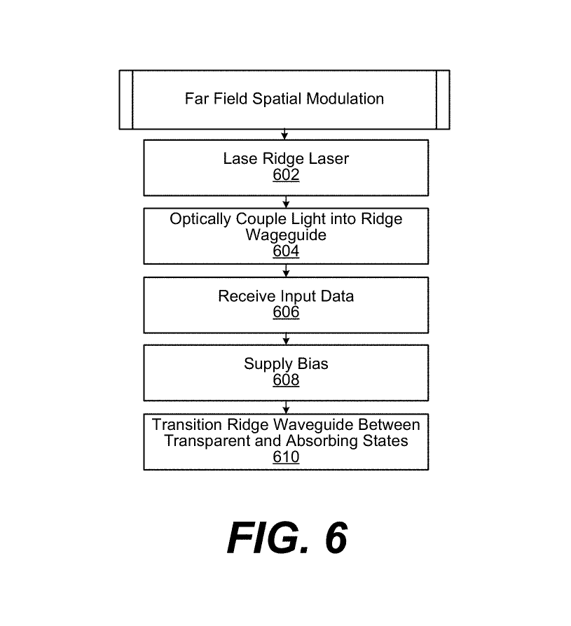

FIG. 6 illustrates a process of far field spatial modulation that can be performed by the optical modulator devices described herein according to various embodiments described herein. The process diagram shown in FIG. 6 provides one example of a sequence of steps that can be used for far field spatial modulation according to the concepts described herein. The arrangement of the steps shown in FIG. 6 is provided by way of representative example. In other embodiments, the order of the steps can differ from that depicted. For example, an order of execution of two or more of the steps can be scrambled relative to the order shown. Also, in some cases, two or more of the steps can be performed concurrently or with partial concurrence. Further, in some cases, one or more of the steps can be skipped or omitted. Additionally, although the process is described in connection with the optical modulator devices shown in FIGS. 1, 4, and 5, similar optical modulator devices can perform the process.

At step 602, the process includes lasing a ridge laser to generate laser light. For example, the driver 52 can provide one or more biases to the ridge laser 20 of the optical modulator 10 shown in FIG. 1. In response to the biases, the ridge laser 20 can lase and generate laser light. Thus, at step 602, the ridge laser 20 can be biased by the driver 52 to emit light from the output facet 21. The light can exhibit power at a particular wavelength or over a relatively narrow range of wavelengths in various embodiments.

At step 604, the process includes optically coupling a fraction of light generated in the ridge laser into a ridge waveguide through waveguide tap formed between the ridge laser and the ridge waveguide. For example, a fraction of the light generated in the ridge laser 20 at step 602 can be tapped coherently from the ridge laser 20 to the ridge waveguide 30 by the waveguide tap 40. Depending upon the structural design of the waveguide tap 40, some characteristics of which are described above with reference to FIG. 4, the fraction of light tapped coherently from the ridge laser 20 to the ridge waveguide 30 can be greater or lower. In one embodiment, about 5-10% of the light generated in the ridge laser 20 is tapped coherently from the ridge laser 20 to the ridge waveguide 30 at step 604, but other ranges are within the scope of the embodiments. The light is tapped into the ridge waveguide 30 for interference with and to modulate the light output from the ridge laser 20. With that amount of light (e.g., about 5-10%) used for interference as described herein, the optical modulation 10 can achieve an extinction ratio of over −3 dB between modulated states.

At step 606, the process includes receiving input data for communication. For example, input data can be received by the driver 52 as part of the input data signals 54 at step 606. In various embodiments, any data can be received. The data can be used to modulate the optical modulator 10 in later steps of the process.

At step 608, the process includes supplying one or more biases to the ridge waveguide based on the input data received at step 606. For example, the driver 52 can supply one or more biases to the ridge waveguide 30 based on the input data received at step 606. As compared to the bias provided to the ridge laser 20 at step 602, the biases supplied at step 608 are provided to the ridge waveguide 30. Further, the biases can be modulated (e.g., turned on and off) based on the input data received at step 606. Thus, the biases can be relied upon to transition the ridge waveguide 30 between transparent and absorbing states in step 610.

At step 610, the process includes transitioning the ridge waveguide 30 between transparent and absorbing states based on the modulated biases supplied at step 608. According to the concepts described herein, when the ridge waveguide 30 is in the absorbing state, any light fed into it from the ridge laser 20 will be absorbed. On the other hand, when the ridge waveguide 30 is in the transparent state, at least a portion of the light fed into it from the ridge laser 20 will be guided through to the output facet 31. The output facet 31 can be designed for relatively little back reflection into the ridge waveguide 30 so that the ridge waveguide 30 does not independently lase. Thus, because the ridge waveguide 30 is not operated as a laser, it can provide high modulation speeds and low chirp levels.

When the ridge laser 20 is biased to emit light from the output facet 21 at step 602 and the ridge waveguide 30 is in the transparent state at step 610, light output from the output facet 31 of the ridge waveguide 30 can interfere with the light output from the output facet 21. The lobe 22 in FIG. 1 is representative of the near-field light output from the output facet 21, which is the main output of light from the optical modulator 10. The lobe 32 in FIG. 1 is representative of the near-field light output from the output facet 31, which is used in the embodiments to distort the light output from the output facet 21. The separation or spatial offset between the output facets 21 and 31 can result, due to light interference, in a distorted, two-lobe near-field response (e.g., the interference of the lobes 22 and 32) at an output of the optical modulator 10 when light is output from both the output facets 21 and 31 (e.g., an OFF state). On the other hand, when the ridge waveguide 30 is absorbing at step 610 and no light is output from the output facet 31, the lobe 22 exhibits a clean, single-lobed near-field response (e.g., an ON state).

The elements described herein can be embodied in hardware, software, or a combination of hardware and software. If embodied as hardware, the components can be implemented as one or more integrated circuits developed using any suitable hardware technology. The hardware technology can include one or more microprocessors, discrete logic circuits having logic gates for implementing various logic functions upon an application of one or more data signals, ASICs having appropriate logic gates, programmable logic devices (e.g., field-programmable gate array (FPGAs), and complex programmable logic devices (CPLDs)).

If embodied in software, program instructions can be embodied in the form of source code that includes human-readable statements written in a programming language and/or machine code that includes machine instructions (e.g., computer-readable instructions) recognizable by a suitable execution system, such as a processor in a computer system or other system. Also, software or program instructions can be embodied or stored on a non-transitory computer-readable medium device. The computer-readable medium can include physical media, such as, magnetic, optical, semiconductor, or other suitable media. Examples of a suitable computer-readable media include, but are not limited to, solid-state drives, magnetic drives, flash memory. Further, any logic or component described herein can be implemented and structured in a variety of ways.

Although embodiments have been described herein in detail, the descriptions are by way of example. The features of the embodiments described herein are representative and, in alternative embodiments, certain features and elements can be added or omitted. Additionally, modifications to aspects of the embodiments described herein can be made by those skilled in the art without departing from the spirit and scope of the present invention defined in the following claims, the scope of which are to be accorded the broadest interpretation so as to encompass modifications and equivalent structures.

Therefore, the following is claimed:

1. An optical modulator device, comprising:
a ridge laser configured to emit light from a first output facet;
a ridge waveguide configured to transition between a transparent state and an absorbing state, the ridge waveguide comprising a second output facet; and
a waveguide tap formed between the ridge laser and the ridge waveguide, the waveguide tap being configured to optically couple a fraction of light generated in the ridge laser into the ridge waveguide.

2. The optical modulator device of claim 1, wherein, in the transparent state of the ridge waveguide, the ridge waveguide is configured to output the fraction of light from the second output facet for interference with the light emitted from the first output facet.

3. The optical modulator device of claim 2, wherein, in the transparent state of the ridge waveguide, the fraction of light from the second output facet interferes with the light emitted from the first output facet to form a distorted, two-lobe far-field intensity response.

4. The optical modulator device of claim 1, wherein, in the absorbing state of the ridge waveguide, the ridge waveguide is configured to absorb the fraction of light optically coupled from the ridge laser to the ridge waveguide.

5. The optical modulator device of claim 1, wherein:
in the transparent state of the ridge waveguide, the ridge waveguide is configured to output the fraction of light from the second output facet for interference with the light emitted from the first output facet of the ridge laser for a first state of optical modulation; and
in the absorbing state of the ridge waveguide, the ridge waveguide is configured to absorb the fraction of light optically coupled from the ridge laser to the ridge waveguide for a second state of optical modulation.

6. The optical modulator device of claim 1, further comprising a driver circuit configured to supply a bias to the ridge waveguide based on an input data signal, to transition the ridge waveguide between the transparent state and the absorbing state.

7. The optical modulator device of claim 1, further comprising a spherical ball lens for focusing the light emitted from the first output facet with or without interference by the fraction of light output from the second output facet.

8. The optical modulator device of claim 1, wherein the first output facet of the ridge waveguide extends beyond the second output facet of the ridge laser.

9. The optical modulator device of claim 8, wherein the first output facet extends beyond the second output facet to phase shift the fraction of light output from the second output facet with respect to the light emitted from the first output facet.

10. A method of optical modulation, comprising:
lasing a ridge laser to emit light from a first output facet of the ridge laser;
optically coupling a fraction of light generated in the ridge laser into a ridge waveguide through waveguide tap formed between the ridge laser and the ridge waveguide, the ridge waveguide comprising a second output facet; and
transitioning the ridge waveguide between a transparent state and an absorbing state to modulate the light output from the first output facet of the ridge laser.

11. The method of optical modulation of claim 10, further comprising:
receiving an input data signal for communication; and
supplying a bias to the ridge waveguide to transition the ridge waveguide between the transparent state and the absorbing state based on the input data signal.

12. The method of optical modulation of claim 10, further comprising:
transitioning the ridge waveguide to the transparent state to emit the fraction of light from the second output facet of the ridge waveguide for interference with the light emitted from the first output facet of the ridge laser for a first state of optical modulation.

13. The method of optical modulation of claim 12, further comprising:
transitioning the ridge waveguide to the absorbing state to absorb the fraction of light optically coupled from the ridge laser to the ridge waveguide for a second state of optical modulation.

14. The method of optical modulation of claim 10, wherein the first output facet of the ridge waveguide extends beyond the second output facet of the ridge laser.

15. The method of optical modulation of claim 14, wherein the first output facet extends beyond the second output facet to phase shift the fraction of light output from the second output facet with respect to the light emitted from the first output facet.

16. An optical modulator device, comprising:
a ridge laser configured to emit light from a first output facet;
a ridge waveguide configured to transition between a transparent state and an absorbing state, the ridge waveguide comprising a second output facet; and
a waveguide tap formed between the ridge laser and the ridge waveguide, the waveguide tap being configured to optically couple a fraction of light generated in the ridge laser into the ridge waveguide, wherein:
in the transparent state of the ridge waveguide, the ridge waveguide is configured to output the fraction of light from the second output facet for interference with the light emitted from the first output facet of the ridge laser for a first state of optical modulation; and
in the absorbing state of the ridge waveguide, the ridge waveguide is configured to absorb the fraction of light optically coupled from the ridge laser to the ridge waveguide for a second state of optical modulation.

17. The optical modulator device of claim 16, further comprising a driver circuit configured to supply a bias to the ridge waveguide based on an input data signal, to transition the ridge waveguide between the transparent state and the absorbing state.

18. The optical modulator device of claim 16, further comprising a spherical ball lens for focusing the light emitted from the first output facet with or without interference by the fraction of light output from the second output facet.

19. The optical modulator device of claim 16, wherein the first output facet of the ridge waveguide extends beyond the second output facet of the ridge laser.

20. The optical modulator device of claim 19, wherein the first output facet extends beyond the second output facet to phase shift the fraction of light output from the second output facet with respect to the light emitted from the first output facet.
